(19) United States
(12) Patent Application Publication
(10) Pub. No.: US 2016/0368051 A1
(43) Pub. Date: Dec. 22, 2016

(54) DEVICE AND METHOD FOR ADDITIVELY PRODUCING AT LEAST ONE COMPONENT REGION OF A COMPONENT

(71) Applicants: EOS GMBH Electro Optical Systems, Krailling (DE); MTU AERO ENGINES AG, München (DE)

(72) Inventors: Andreas Jakimov, Munich (DE); Georg Schlick, Munich (DE); Herbert Hanrieder, Hohenkammer (DE); Martin Leuterer, Olching (DE)

(21) Appl. No.: 14/898,909

(22) PCT Filed: Jun. 6, 2014
(86) PCT No.: PCT/EP2014/061904

§ 371 Date: Dec. 16, 2015

(30) Foreign Application Priority Data
Jun. 20, 2013 (DE) 10 2013 211 679.9

(51) Int. Cl. B22F 3/105; B33Y 30/00; B33Y 10/00

(52) U.S. Cl. CPC B22F 3/1055; B33Y 10/00; B33Y 30/00; B22F 2003/1056

(57) ABSTRACT

The invention relates to a device (10) for generative production of at least one component area of a component (12), in particular of a component (12) of a flow machine, wherein the device (10) includes at least one coater (14) for applying at least one powder layer of a component material to at least one construction and joining zone (20) of at least one lowerable component platform (16), wherein the coater (14) is movable relative to the component platform (16); and at least one radiation source for generating at least one high-energy beam (22), by means of which the powder layer can be locally melted and/or sintered to a component layer in the area of the construction and joining zone (20). In addition, at least one heating device (24, 28) is disposed on the coater (14).

The invention relates to a device for generative production of at least one component area of a component, in particular of a component of a flow machine, according to the preamble of claim 1 as well as to a method for generative production of at least one component area of a component, in particular of a component of a flow machine, according to the preamble of claim 13.

Methods and devices for producing components are known in a great plurality. In particular, generative manufacturing methods (so-called rapid manufacturing or rapid prototyping methods) are known, in which the component is constructed by powder bed based, additive manufacturing methods in layers. Predominantly metallic components can for example be produced by laser or electron beam melting or sintering methods. Therein, at least one powdery component material is first applied to a component platform in layers in the area of a construction and joining zone of the device. Subsequently, the component material is locally melted and/or sintered in layers by supplying energy by means of at least one high-energy beam, for example an electron or laser beam, to the component material in the area of the construction and joining zone. Therein, the high-energy beam is controlled depending on layer information of the component layer respectively to be produced. After melting and/or sintering, the component platform is lowered by a predefined layer thickness in layers. Thereafter, the mentioned steps are repeated up to the final completion of the component.

From the prior art, in particular, generative production methods for the production of components of a flow machine, such as for example components of an aircraft engine or a gas turbine, are also known, e.g. the method described in DE 10 2009 051 479 A1 or a corresponding device for producing a component of a flow machine.

In this method, by application of at least one powdery component material to a component platform in the area of a construction and joining zone in layers as well as locally melting or sintering the component material by means of energy supplied in the area of the construction and joining zone in layers, a corresponding component is produced. Herein, the supply of the energy is effected via laser beams such as for example CO2 laser, Nd:YAG laser, Yb fiber laser as well as diode laser or by electron beams. In the method described in DE 10 2009 051 479 A1, furthermore, the produced component or the construction and joining zone is heated to a temperature just below the melting point of the component material by means of a zone furnace to maintain a directionally solidified or monocrystalline crystal structure.

From DE 10 2006 058 949 A1, a device and a method for fast production and repair of blade tips of blades of a gas turbine, in particular of an aircraft engine, are also known, wherein inductive heating is employed together with laser or electron beam sintering.

Inductive heating of the component to be produced in association with the generative production of a component with the aid of selective laser melting is also described in EP 2 359 964 A1.

WO 2008/071165 A1 again describes a device and a method for repairing turbine blades of gas turbines by means of powder deposition welding, wherein a radiation source like a laser or an electron beam is used for deposition welding. At the same time, a heating device for heating the blade to be repaired is provided via an induction coil.

DE 10 2012 206 122 A1 describes a device for generative production of components by means of laser powder deposition welding and/or selectively irradiating a powder bed, wherein the device has at least one induction coil movably disposed relative to one or more powder bed rooms. Therein, the induction coils are linearly movable along separately formed rail assemblies. By the local inductive heating of the component individually adapted to the geometry of the component to be produced, it is possible that hot crack formations are reliably prevented in the production of the component, in particular in use of high-temperature alloys for the generative manufacture.

However, the circumstance is to be considered disadvantageous in the known methods including movable induction coils that an additional instrumental setup such as for example additional rail assemblies is required hereto. Thereby, the device increases in price and subsequent retrofitting of such devices without movable induction coils to devices with corresponding induction coils often is not possible or only with high constructive expense.

Therefore, it is the object of the present invention to provide a device of the initially mentioned kind, which has a simplified constructive structure and allows relative simple retrofitting with at least one movable heating device. Furthermore, it is the object of the present invention to provide a method of the initially mentioned kind, which is constructively simply realizable.

According to the invention, these objects are solved by a device having the features of claim 1 for generative production of at least one component area of a component, by a corresponding method having the features of claim 13 as well as a coater for use in a device for generative production of at least one component area of a component having the features of claim 18. Advantageous configurations with convenient developments of the invention are specified in the respective dependent claims, wherein advantageous configurations of the device are to be regarded as advantageous configurations of the method as well as of the coater and vice versa.

A first aspect of the invention relates to a device for generative production of at least one component area of a component, in particular of a component of a flow machine. Therein, the device includes at least one coater for applying at least one powder layer of a component material to at least one construction and joining zone of at least one lowerable component platform, wherein the coater is movable relative to the component platform. In addition, the device includes at least one radiation source for generating at least one high-energy beam, by means of which the powder layer can be locally melted and/or sintered to a component layer in the area of the construction and joining zone. Furthermore, at least one heating device is disposed on the coater. By the arrangement of the heating device on the coater, it is possible to heat the powder layer of the component material before, during and/or after exposure by means of the radiation source in this area. Due to this heating by means of the heating device, hot crack formations are reliably avoided in particular in use of high-temperature alloys as the component material. Since the heating device is disposed on the coater, first, additional moving units for moving the heating device in the area of the construction and joining zone of the component can be omitted. The heating device can be non-movably disposed on the coater such that it is moved along or over the construction and joining zone of the component platform by the movement of the coater. Thereby, simple constructive structure of the device is overall constituted. In addition, already present devices for generative production of components can be retrofitted with a corresponding heating device, which is disposed on the coater. Then, it is moved over the construction and joining zone of the component platform with the coater via a corresponding moving unit of the coater. By the terms of “disposed” or “arrangement”, it is to be understood that the heating device can be directly or indirectly connected to the coater. For example, a mechanical connection to the coater is possible.

In further advantageous configurations of the device according to the invention, the heating device is formed such that heating of at least the powder layer of the component layer is effected by means of inductive heating and/or electromagnetic radiation. Therein, the heating device can include at least one laser and/or at least one microwave and/or at least one infrared radiation source and/or at least one UV radiation source. Furthermore, the heating device can include at least one induction coil. Therein, by induction coil, within the scope of the present invention, each device is understood, which can generate inductive heating, thus for example independently of the number of the windings such that the induction coil can for example also be referred to as induction loop. Therein, it is possible that the device includes multiple induction coils disposed on the coater, which are disposed in one or more planes parallel to a surface of the construction and joining zone. In particular, two induction coils can be operated in arrangement crossed to each other, wherein in particular in the crossing area the high-energy beam of the radiation source can be provided for melting and/or sintering the powdery component material. In a further advantageous configuration, an induction coil can be non-movably disposed on the coater, and a further induction coil can be movably disposed on the coater via a moving unit. By the terms of “disposed” or “arrangement”, it is to be understood that the connection between the mentioned elements is directly or indirectly formed.

In further advantageous configurations of the device according to the invention, the at least one heating device is movably disposed on the coater. Therein, the coater can include at least one moving unit, on which at least one heating device is in turn disposed. Therein, the possibility advantageously arises to move the heating device also opposite to the direction of movement of the coater in order to thus be able to subject a further area of the construction and joining zone to heating by the heating device. However, it is in particular also possible that the device includes at least one heating device movably disposed on the coater and at least one heating device non-movably disposed on the coater. By the arrangement of at least two heating devices on the coater, in turn, a larger area of the construction and joining zone of the component platform and the component material applied in this area can advantageously be heated. By the terms of “disposed” or “arrangement”, it is to be understood that the connection between the mentioned elements is directly or indirectly formed.

The relative movability of the coater relative to the component platform can be effected either by the movement of the coater by means of the corresponding moving unit or by moving the component platform. In the last mentioned embodiment, a separate moving unit of the coater can optionally be omitted.

In a further advantageous configuration of the device according to the invention, the coater includes at least one movable blade such that the blade is at least partially retractable into the coater during exposure of the powder layer in the area of the construction and joining zone by means of the high-energy beam. Therein, by the term of “blade”, all of the usable smoothing devices such as for example blades, doctor blade, lips, combs or rollers are to be understood. Thereby, it can advantageously be ensured that damage of the blade by the high-energy beam cannot occur if the blade is disposed on the coater such that it at least partially protrudes into the exposure area during the exposure procedure by the high-energy beam.

In a further advantageous configuration of the device according to the invention, the device includes at least one focusing device for focusing the high-energy beam. Thereby, it is ensured that the high-energy beam always remains focused to the layer of the powdery component material to be melted and/or sintered independently of a possible up or down movement of the component platform.

In further advantageous configurations of the device according to the invention, the high-energy beam is a laser or electron beam.

A second aspect of the invention relates to a method for producing at least one component area of a component, in particular of a component of a flow machine. Therein, the method at least includes the following steps:

a) applying at least one powdery component material in layers by means of at least one coater to at least one component platform in the area of a construction and joining zone, wherein the coater is movable relative to the component platform;

b) locally melting and/or sintering the component material in layers by supplying energy by means of at least one high-energy beam in the area of the construction and joining zone for forming a component layer, wherein heating at least of the component material disposed in the area of the construction and joining zone is effected by means of at least one heating device before and/or during and/or after locally melting and/or sintering the component material in layers;

c) lowering the component platform in layers by a predefined layer thickness; and

d) repeating the steps a) to c) until completion of the component area.

Therein, the at least one heating device is disposed on the coater, and during supply of energy by means of the high-energy beam in the area of the construction and joining zone, at least one blade disposed on the coater is moved away from a surface of the component material. By the arrangement of the at least one heating device on the coater, in turn, a constructively simple solution for moving the heating device in the area of the construction and joining zone is ensured. By the terms of “disposed” or “arrangement”, it is to be understood that the heating device can be directly or indirectly connected to the coater. For example, a mechanical connection to the coater is possible. In addition, it is ensured that by moving the coater or a blade disposed on the coater away from the surface of the component material during exposure by means of the high-energy beam, damage to the coater or of the blade disposed thereon is avoided. Therein, the blade can be movably formed such that the blade is at least partially retractable in the coater during exposure of the powder layer in the area of the construction and joining zone by means of the high-energy beam. However, it is also possible that for moving the blade away from the surface of the component material, lowering the component platform is effected. During lowering the component platform, advantageously, variation of the positioning of a beam focus of the high-energy beam relative to the surface of the component material is effected. For example, focusing of the high-energy beam on the surface of the component material can be effected. Thereby, optimum melting and/or sintering of the component material in this area is constituted.

A third aspect of the invention relates to a coater for use in a device for generative production of at least one component area of a component. According to the invention, the coater is movable relative to a component platform of the device and formed for arrangement of at least one heating device. The coater according to the invention allows a powder layer of a component material being heated before, during and/or after exposure by means of a radiation source of the device in this area. Due to this heating by means of the heating device, hot crack formations are reliably avoided, in particular in use of high-temperature alloys as the component material. Since the heating device is disposed on the coater, first, additional moving units for moving the heating device in the area of the construction and joining zone of the component can be omitted. By the terms of “disposed” or “arrangement”, it is to be understood that the coater can be directly or indirectly connected to the heating device. For example, a mechanical connection to the heating device is possible.

Further features of the invention are apparent from the claims, the embodiments as well as based on the drawings. The features and feature combinations mentioned above in the description as well as the features and feature combinations mentioned below in the embodiments are usable not only in the respectively specified combination, but also in other combinations without departing from the scope of the invention. There shows:

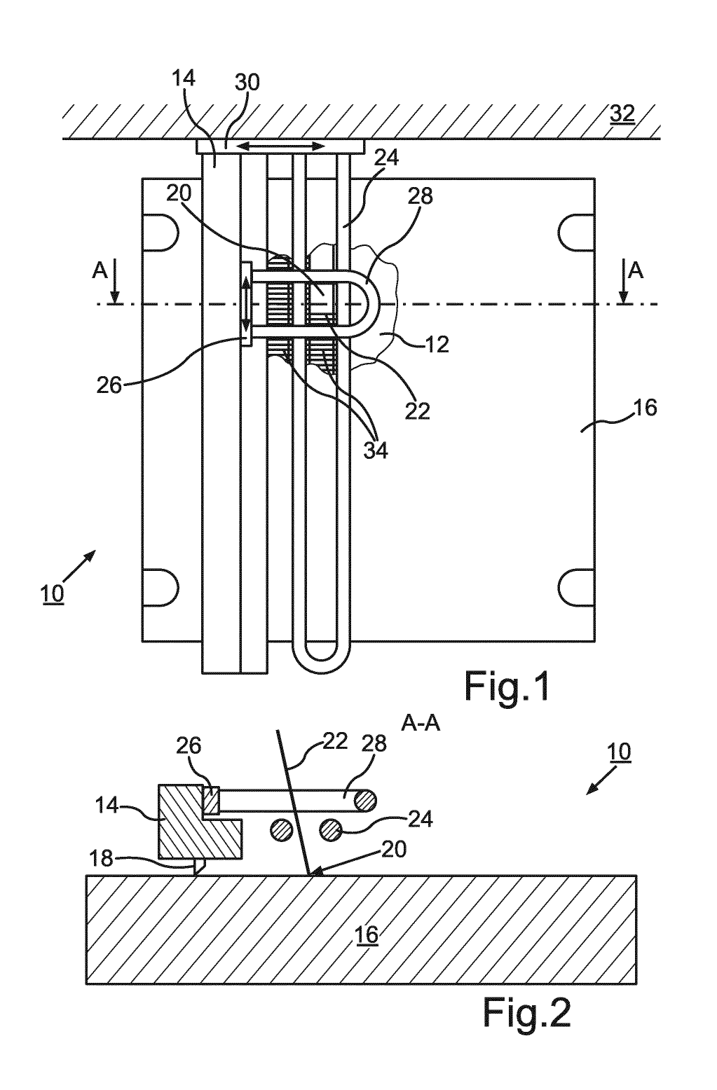

FIG. 1 a schematically illustrated plan view of a device according to the invention for producing at least one component area of a component according to a first embodiment;

FIG. 2 a schematic sectional representation of the device according to FIG. 1;

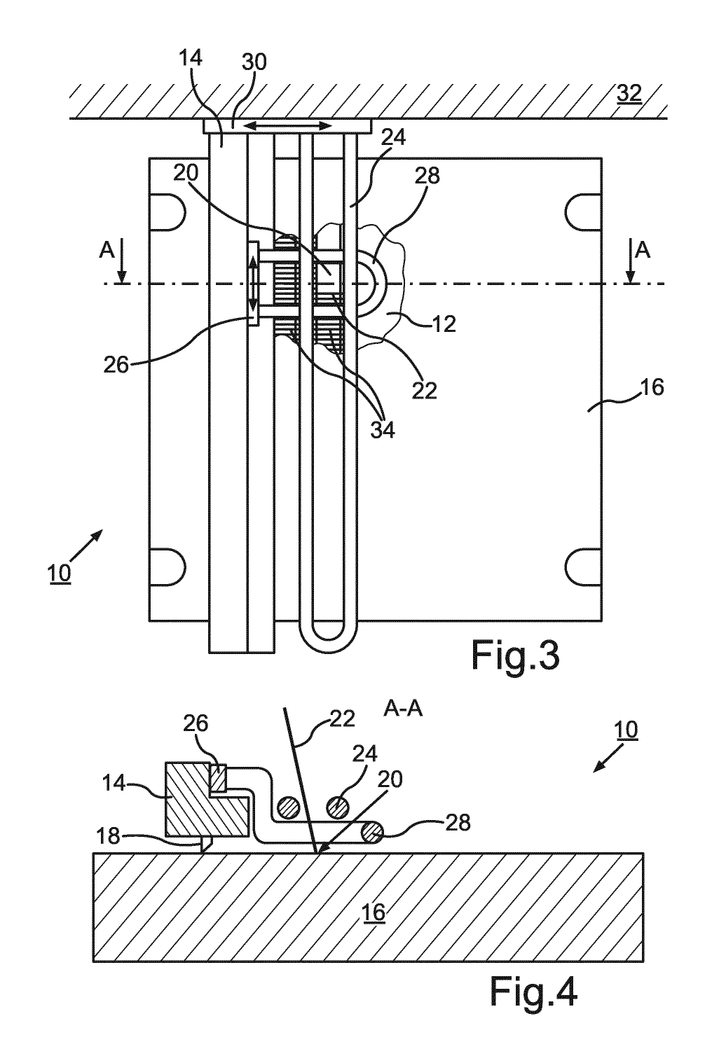

FIG. 3 a schematically illustrated plan view of a device according to the invention for producing at least one component area of a component according to a second embodiment; and

FIG. 4 a schematic sectional representation of the device according to FIG. 3.

FIG. 1 shows a schematically illustrated plan view of a device 10 according to the invention for generative production of at least one component area of a component 12, in particular of a component 12 of a flow machine. In particular, it can be a component of a turbine or of a compressor of an aircraft engine. In addition, the device 10 has a coater 14 for applying at least one powder layer of a component material (not illustrated) to at least one construction and joining zone 20 of a lowerable component platform 16. One recognizes that the coater 14 can be moved by means of a moving unit 30, which is connected to a machine rack 32 of the device 10. Therein, the movement of the coater 14 is effected above and along the component platform 16 such that uniform application of the powdery component material to the component platform 16 in layers is possible.

Furthermore, one recognizes that a first induction coil 24 is disposed on the moving unit 30 of the coater 14. Approximately perpendicularly to the first induction coil 24, a second induction coil 28 is disposed on a moving unit 26. The moving unit 26 in turn is disposed on the coater 14 such that the second induction coil 28 can be moved along a longitudinal extension of the coater 14. In the illustrated embodiment, the two induction coils are formed in arrangement crossed to each other. One recognizes that by such an arrangement the entire area of the component platform 16 is covered by means of the induction coils 24, 28 and thus can be heated. Furthermore, it becomes clear that a high-energy beam 22, in particular a laser or electron beam, can be directed to the powder layer of the component material in the area of a construction and joining zone 20 between the induction coils 24, 28. In particular, the high-energy beam 22 is oriented such that it can pass between a crossing area of the induction coils 24, 28. In addition, in FIG. 1, beam tracks 34 formed by the spot-shaped high-energy beam 22, in particular laser tracks, are illustrated. In the area of the beam tracks 34, melting and/or sintering of the component material have already occurred.

In addition, one recognizes that by the arrangement of the induction coils 24, 28 on the coater 14, they do not have to be removed anymore from the working area of the coater 14 for coating. By heating the powder layer by means of the induction coils 24, 28 in the area of the construction and joining zone 20, it is possible to achieve consistent induction conditions on the one hand before, during and after melting the component material by means of the high-energy beam 22 and with progression of the solidification front such that consistent melting conditions with defined, local temperature gradients are adjustable with high production speeds. On the other hand, the formation of cracks and the like in solidification is avoided at the same time.

FIG. 2 shows a schematic sectional representation of the device 10 according to the line A-A in FIG. 1. One recognizes that the second induction coil 28 disposed on the coater 14 by means of the moving unit 26 is disposed in a plane above the first induction coil 24 disposed on the moving unit 30 of the coater 14 relative to the component platform 16. In addition, one recognizes that the coater 14 has a blade 16 for application of the powdery component material (not illustrated) in layers to the component platform 16. Therein, the blade 18 is movably formed such that it is at least partially retractable into the coater 14 during exposure of the powder layer in the area of the construction and joining zone 20 by means of the high-energy beam 22. Alternatively to the blade 18, other smoothing devices such as for example doctor blade, lips, combs or rollers can also be used.

FIG. 3 shows a schematically illustrated plan view of a device 10 for generative production of at least one component area of a component 12, in particular of a component 12 of a flow machine, according to a second embodiment. The structure of the second embodiment of the device 10 illustrated in FIG. 3 substantially corresponds to the structure of the first embodiment of the device 10 illustrated in FIG. 1. However, from the schematic sectional representation of the device 10 shown in FIG. 4, it becomes clear that the second induction coil 28, which is movably disposed on the coater 14 by means of the moving unit 26, is disposed in a plane under a plane of the first induction coil 24 relative to the component platform 16.

The embodiments of the device 10 illustrated in FIGS. 1 to 4 can additionally also include a control and/or regulating device and/or a temperature sensing device, wherein by the control and/or regulating device, the position and/or the power of the induction coil(s) 24, 28 are controllable and/or regulatable depending on the measurement results of the temperature sensing device.

1-18. (canceled)

19. A device for generative production of at least one component area of a component of a flow machine, comprising:
at least one coater for applying at least one powder layer of a component material to at least one construction and joining zone of at least one lowerable component platform, wherein the coater is movable relative to the component platform;
at least one radiation source for generating at least one high-energy beam, by which the powder layer can be locally melted and/or sintered to a component layer in the area of the construction and joining zone; and
at least one heating device is disposed on the coater.

20. The device according to claim 19, wherein the heating device is configured and arranged such that heating of at least the powder layer of the component material is effected by means of inductive heating and/or electromagnetic radiation.

21. The device according to claim 20, wherein the heating device includes at least one laser and/or at least one microwave and/or at least one infrared radiation source and/or at least one UV radiation source.

22. The device according to claim 20, wherein the heating device includes at least one induction coil.

23. The device according to claim 21, wherein the heating device includes at least one induction coil.

24. The device according to claim 22, wherein the device includes multiple induction coils disposed on the coater, which are disposed in one or more planes parallel to a surface of the construction and joining zone.

25. The device according to claim 23, wherein the device includes multiple induction coils disposed on the coater, which are disposed in one or more planes parallel to a surface of the construction and joining zone.

26. The device according to claim 19, wherein the heating device is non-movably disposed on the coater.

27. The device according to claim 19, wherein the heating device is movably disposed on the coater.

28. The device according to claim 27, wherein the coater includes at least one moving unit, on which at least one heating device is disposed.

29. The device according to claim 27, wherein the device includes at least one heating device movably disposed on the coater and at least one heating device non-movably disposed on the coater.

30. The device according to claim 28, wherein the device includes at least one heating device movably disposed on the coater and at least one heating device non-movably disposed on the coater.

31. The device according to claim 19, wherein the coater includes at least one movable blade such that the blade is at least partially retractable into the coater during exposure of the powder layer in the area of the construction and joining zone by means of the high-energy beam.

32. The device according to claim 19, wherein the device includes at least one focusing device for focusing the high-energy beam.

33. The device according to claim 19, wherein the high-energy beam is a laser or electron beam.

34. A method for producing at least one component area of a component of a flow machine, including at least the following steps:
a) applying at least one powdery component material in layers by means of at least one coater to at least one component platform (16) in the area of a construction and joining zone, wherein the coater is movable relative to the component platform;
b) locally melting and/or sintering the component material in layers by supplying energy by means of at least one high-energy beam in the area of the construction and joining zone for forming a component layer, wherein before and/or during and/or after locally melting and/or sintering the component material in layers, heating of at least the component material disposed in the area of the construction and joining zone is effected by means of at least one heating device;
c) lowering the component platform in layers by a predefined layer thickness; and
d) repeating the steps a) to c) until completion of the component area, and wherein the at least one heating device is disposed on the coater.

35. The method according to claim 34, wherein during the supply of energy by means of the high-energy beam in the area of the construction and joining zone, at least one blade disposed on the coater is moved away from a surface of the component material.

36. The method according to claim 35, wherein the blade is movably formed such that the blade is at least partially retractable into the coater during exposure of the powder layer in the area of the construction and joining zone by means of the high-energy beam.

37. The method according to claim 35, wherein for moving the blade away from the surface of the component material, lowering of the component platform is effected.

38. The method according to claim 37, wherein during lowering of the component platform, variation of the positioning of a beam focus of the high-energy beam relative to the surface of the component material is effected.

39. A coater for use in a device for generative production of at least one component area of a component, wherein the coater is movable relative to a component platform of the device and is formed for arrangement on at least one heating device.
